(19) United States
(12) Patent Application Publication
(10) Pub. No.: US 2026/0012263 A1
(43) Pub. Date: Jan. 8, 2026

(54) WAVELENGTH CONVERTER AND WAVELENGTH CONVERSION METHOD

(71) Applicant: NEC Corporation, Tokyo (JP)

(72) Inventor: John Kenji David CLARK, Tokyo (JP)

(73) Assignee: NEC Corporation, Tokyo (JP)

(21) Appl. No.: 19/250,226

(22) Filed: Jun. 26, 2025

(30) Foreign Application Priority Data
Jul. 8, 2024 (JP) 2024-109483

(51) Int. Cl. H04B 10/572; H04B 10/58

(52) U.S. Cl. CPC H04B 10/572; H04B 10/58

(57) ABSTRACT

A reception means splits a quadrature phase-modulated optical signal of a first wavelength into first and second optical signals, causes first and second optical signals to interfere with first and second local oscillation lights, the phase of the second local oscillation light being shifted to have a quadrature phase with respect to the first local oscillation light to output in-phase and quadrature phase analog signals. An analog compensation means performs analog compensation on the in-phase and quadrature phase analog signals. A transmission means modulates the first and second transmission lights of the second wavelength into first in-phase and quadrature phase optical signals based on the analog compensated in-phase and quadrature phase analog signals, multiplexes the first in-phase and quadrature phase optical signals whose phases have been shifted to cancel the phase shift of the second local oscillation light, and outputs a quadrature phase-modulated optical signal of the second wavelength.

### INCORPORATION BY REFERENCE

This application is based upon and claims the benefit of priority from Japanese patent application No. 2024-109483, filed on Jul. 8, 2024, the disclosure of which is incorporated herein in its entirety by reference.

### TECHNICAL FIELD

The present disclosure relates to a wavelength converter and a wavelength conversion method.

### BACKGROUND ART

As an apparatus used in an optical network, a wavelength converter for converting an optical signal of a certain wavelength into an optical signal of another wavelength is known. For example, as disclosed in Japanese Unexamined Patent Application Publication No. 2024-036713, a wavelength converter is widely used that is configured to wavelength-convert a quadrature phase-modulated optical signal including an in-phase (I) phase and a quadrature (Q) phase orthogonal to each other.

The wavelength converter converts the received optical signal into an analog signal by coherent detection. Then, by modulating light having a wavelength different from that of the received optical signal based on the converted analog signal, an optical signal having another wavelength is output. In coherent detection, a received signal is branched into two. Thereafter, one branched optical signal is caused to interfere with local oscillation light, thereby generating an I-phase optical signal. In addition, the other branched optical signal is caused to interfere with local oscillation light whose phase is shifted by 90°, thereby generating a Q-phase optical signal. Then, by photoelectrically converting the I-phase and Q-phase optical signals, I-phase and Q-phase analog signals can be obtained.

### SUMMARY

In a general wavelength converter, a Q-phase optical signal is obtained by interfering local oscillation light, phase shifted by 90° by a phase shifter, with a received optical signal, but it is difficult to strictly set the phase shift by the phase shifter to 90°. For example, the phase shift given to the local oscillation light by the phase shifter may deviate from 90° due to a manufacturing error of the phase shifter or the like. In addition, it is assumed that the phase shifter is used in a certain wavelength range, but it is difficult to design the phase shifter such that the phase shift is 90° over the entire wavelength range. Therefore, imbalance occurs between the I-phase analog signal and the Q-phase analog signal. Imbalance between the I-phase and the Q-phase leads to deterioration in quality of the optical signal after the wavelength conversion.

A wavelength converter according to an example aspect of the present disclosure includes a reception means for receiving a quadrature phase-modulated optical signal of a first wavelength, splitting the received optical signal into first and second optical signals, causing the first optical signal to interfere with a first local oscillation light of the first wavelength, and causing the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals, an analog compensation means for performing analog compensation on the in-phase analog signal and the quadrature phase analog signal, and a transmission means for modulating first and second transmission lights of a second wavelength different from the first wavelength into a first in-phase optical signal and a first quadrature phase optical signal, respectively, based on the analog compensated in-phase analog signal and quadrature phase analog signal, shifting a phase of the first quadrature phase optical signal to cancel a shift amount included in a phase shift given to the second local oscillation light by the reception means, multiplexing the first in-phase optical signal and the first quadrature phase optical signal after the phase shift, and outputting a quadrature phase-modulated optical signal of the second wavelength.

A wavelength conversion method according to an example aspect of the present disclosure includes: receiving a quadrature phase-modulated optical signal of a first wavelength, splitting the received optical signal into first and second optical signals, causing the first optical signal to interfere with a first local oscillation light of the first wavelength, and causing the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals, performing analog compensation on the in-phase analog signal and the quadrature phase analog signal, modulating first and second transmission light of a second wavelength different from the first wavelength into a first in-phase optical signal and a first quadrature phase optical signal, respectively, based on the analog compensated in-phase analog signal and quadrature phase analog signal, shifting a phase of the first quadrature phase optical signal to cancel a shift amount included in a phase shift given to the second local oscillation light, multiplexing the first in-phase optical signal and the first quadrature phase optical signal after the phase shift, and outputting a quadrature phase-modulated optical signal of the second wavelength.

According to the present disclosure, a wavelength converter and a wavelength conversion method can be provided for wavelength-converting an optical signal while maintaining signal quality with a simple configuration.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram schematically illustrating a configuration of a wavelength converter according to one example embodiment;

FIG. 2 is a diagram illustrating a configuration of the wavelength converter according to one example embodiment in more detail;

FIG. 3 is a diagram schematically illustrating a configuration of a wavelength converter according to one example embodiment;

FIG. 4 is a flowchart of an operation of the wavelength converter according to one example embodiment;

FIG. 5 is a diagram schematically illustrating a configuration of the wavelength converter according to one example embodiment; and

FIG. 6 is a flowchart of an operation of the wavelength converter according to one example embodiment.

### EXAMPLE EMBODIMENT

### First Example Embodiment

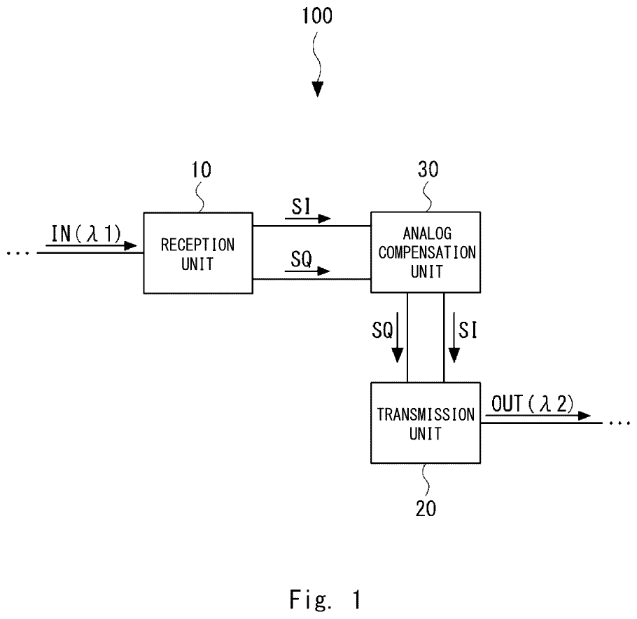

A wavelength converter according to a first example embodiment will be described. The wavelength converter is configured to convert an input optical signal into an optical signal of another wavelength and output the optical signal. FIG. 1 is a diagram schematically illustrating a configuration of a wavelength converter according to one example embodiment. A wavelength converter 100 includes a reception unit 10, a transmission unit 20, and an analog compensation unit 30. The reception unit 10 is configured as a so-called reception front end of the wavelength converter 100. The transmission unit 20 is configured as a so-called transmission front end of the wavelength converter 100.

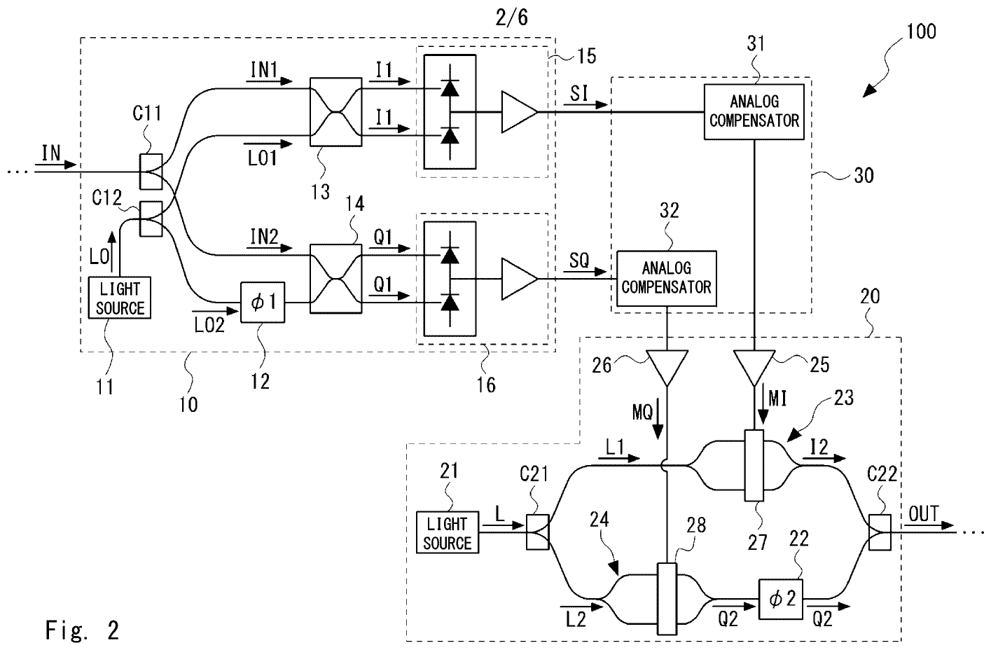

The configuration of the wavelength converter 100 will be described in more detail. FIG. 2 is a diagram illustrating a configuration of the wavelength converter according to one example embodiment in more detail.

The reception unit 10 receives a quadrature phase-modulated optical signal IN having a wavelength λ1. Hereinafter, the wavelength λ1 is also referred to as a first wavelength. The reception unit 10 outputs an I-phase analog signal SI, which is an in-phase (I-phase) analog signal, and a Q-phase analog signal SQ, which is a quadrature phase (Q-phase) analog signal, by coherently detecting the optical signal IN. As illustrated in FIG. 2, the reception unit 10 includes a light source 11, a phase shifter 12, optical couplers 13 and 14, photoelectric converters 15 and 16, and optical couplers C11 and C12. The phase shifter 12, the optical couplers 13 and 14, and the optical couplers C11 and C12 constitute a so-called 90° hybrid. The optical couplers C11 and C12 are also referred to as first and second optical splitting unit or optical splitting means.

The optical signal IN is split into optical signals IN1 and IN2 by the optical coupler C11. The optical signals IN1 and IN2 are guided to the optical couplers 13 and 14, respectively. Hereinafter, the optical signals IN1 and IN2 are also referred to as first and second optical signals, respectively.

The light source 11 is configured as, for example, a wavelength variable laser light source, and outputs local oscillation light LO having a wavelength λ1. The local oscillation light LO is split into local oscillation lights LO1 and LO2 by the optical coupler C12. The local oscillation lights LO1 and LO2 are guided to the optical coupler 13 and the phase shifter 12, respectively. Hereinafter, the local oscillation light LO1 and the local oscillation light LO2 are also referred to as first and second local oscillation lights, respectively. The light source 11 is also referred to as a first light source.

The optical coupler 13 is configured as a 2-input 2-output optical coupler. The optical signal IN1 is input to one input port of the optical coupler 13, and the local oscillation light LO1 is input to the other input port. The optical coupler 13 outputs the I-phase optical signal I1 composed of two complementary optical signals obtained by causing the optical signal IN1 and the local oscillation light LO1 to interfere with each other to the photoelectric converter 15 via two output ports. Hereinafter, the I-phase optical signal I1 is also referred to as a second in-phase optical signal. The optical coupler 13 is also referred to as a first interfering means.

The phase shifter 12 is configured to give a phase shift of π/2 to the local oscillation light LO2. Here, π/2 which is a phase shift given to the local oscillation light LO2 by the phase shifter 12 is a design value, and the phase shift actually given to the local oscillation light LO2 by the phase shifter 12 due to a manufacturing error or the like is obtained by adding a shift amount due to the error to π/2. In addition, due to the dispersion of the phase shifter, the shift amount of the phase shift may differ depending on the value of the wavelength λ1. Therefore, here, the actual phase shift given to the local oscillation light LO2 by the phase shifter 12 is set as φ1=π/2+φₑᵣᵣ(λ1). The local oscillation light LO2 after the phase shift is output to the optical coupler 14. The phase shifter 12 is also referred to as a first phase shifter.

The optical coupler 14 is configured as a 2-input 2-output optical coupler. The optical signal IN2 is input to one input port of the optical coupler 14, and the local oscillation light LO2 phase shifted by the phase shifter 12 is input to the other input port. The optical coupler 14 outputs the Q-phase optical signal Q1 composed of two complementary optical signals obtained by causing the optical signal IN2 and the local oscillation light LO2 after the phase shift to interfere with each other to the photoelectric converter 16 via two output ports. Hereinafter, the Q-phase optical signal Q1 is also referred to as a second quadrature phase optical signal. The optical coupler 14 is also referred to as a second interfering means.

The photoelectric converter 15 is configured as a balanced detector in which two photodiodes (hereinafter, referred to as PD) are connected in cascade. Here, the PD on the upper side of the drawing is defined as the + side, and the PD on the lower side of the drawing is defined as the − side. One PD of the photoelectric converter 15 receives the I-phase optical signal I1 output from one output port of the optical coupler 13. The other PD of the photoelectric converter 15 receives the I-phase optical signal I1 output from the other output port of the optical coupler 13. Then, the photoelectric converter 15 converts the current signal output from a node between the two PDs into an I-phase analog signal SI by, for example, a transimpedance amplifier. The photoelectric converter 15 is also referred to as a first photoelectric converter.

Similarly to the photoelectric converter 15, the photoelectric converter 16 is configured as a balanced detector in which two PDs are connected in cascade. Here, the PD on the upper side of the drawing is defined as the + side, and the PD on the lower side of the drawing is defined as the − side. One PD of the photoelectric converter 16 receives the Q-phase optical signal Q1 output from one output port of the optical coupler 14. The other PD of the photoelectric converter 16 receives the Q-phase optical signal Q1 output from the other output port of the optical coupler 14. Then, the photoelectric converter 16 converts the current signal output from a node between the two PDs into a Q-phase analog signal SQ by, for example, a transimpedance amplifier. The photoelectric converter 16 is also referred to as a second photoelectric converter.

The analog compensation unit 30 includes analog compensators 31 and 32. The analog compensators 31 and 32 appropriately perform a compensation process on the I-phase analog signal SI and the Q-phase analog signal SQ, respectively. Then, the analog compensators 31 and 32 output the I-phase analog signal SI and the Q-phase analog signal SQ after the compensation to the transmission unit 20, respectively. The I-phase analog signal SI may be a differential analog signal, and may include two analog signals of an I-phase analog signal SI+ and an I-phase analog signal SI−. The Q-phase analog signal SQ may be a differential analog signal, and may include two analog signals of a Q-phase analog signal SQ+ and a Q-phase analog signal SQ−. In a case where the I-phase analog signal SI and the Q-phase analog signal SQ are differential analog signals, the analog compensators 31 and 32 may include + and − analog compensators, respectively. The analog compensators 31 and 32 may be compensators that receive differential analog signals and output differential analog signals.

The transmission unit 20 modulates the light having the wavelength λ2 based on the I-phase analog signal SI and the Q-phase analog signal SQ to output the quadrature phase-modulated optical signal OUT. Hereinafter, the wavelength λ2 is also referred to as a second wavelength. The transmission unit 20 includes a light source 21, a phase shifter 22, a Mach-Zehnder modulators (hereinafter referred to as MZ modulator) 23 and 24, drivers 25 and 26, and optical couplers C21 and C22. The optical coupler C21 is also referred to as a third optical splitting unit or splitting means. The optical coupler C22 is also referred to as an optical multiplexing unit or optical multiplexing means. The drivers 25 and 26 are also referred to as first and second drivers, respectively.

The light source 21 is configured as, for example, a wavelength variable laser light source, and outputs transmission light L having the wavelength λ2. The transmission light L is split into transmission light L1 and transmission light L2 by the optical coupler C21. The transmission lights L1 and L2 are guided to the MZ modulators 23 and 24, respectively. Hereinafter, the transmission light L1 and the transmission light L2 are also referred to as first and second transmission lights, respectively. The light source 21 is also referred to as a second light source.

The MZ modulator 23 branches the transmission light L1 into two arms. Electrodes 27 are provided on the two arms. An I-phase modulation signal MI output by the driver 25 based on the I-phase analog signal SI received from the analog compensator 31 is applied to the electrode 27. As a result, the transmission light L1 is modulated according to the I-phase modulation signal MI, and the I-phase optical signal 12 is output from the MZ modulator 23. Although the electrode 27 is illustrated as one electrode in the drawing, this is for simplification. Therefore, the MZ modulator 23 may be configured as various general MZ modulators such as a configuration in which an electrode is provided in each of two arms, and different modulation signals and bias voltages are applied. The I-phase optical signal I2 is also referred to as a first in-phase optical signal. The MZ modulator 23 is also referred to as a first modulator.

The MZ modulator 24 branches the input transmission light L2 into two arms. Electrodes 28 are provided on the two arms. A Q-phase modulation signal MQ output by the driver 26 based on the Q-phase analog signal SQ received from the analog compensator 32 is applied to the electrode 28. As a result, the transmission light L2 is modulated according to the Q-phase modulation signal MQ, and the Q-phase optical signal Q2 is output from the MZ modulator 24. Although the electrode 28 is illustrated as one electrode in the drawing, this is for simplification. Therefore, the MZ modulator 24 may be configured as various general MZ modulators such as a configuration in which an electrode is provided in each of two arms, and different modulation signals and bias voltages are applied. Hereinafter, the Q-phase optical signal Q2 is also referred to as a first quadrature phase optical signal. The MZ modulator 24 is also referred to as a second modulator.

The phase shifter 22 is configured to apply a phase shift of φ2=π/2+φ_{MOD} to the Q-phase optical signal Q2. Here, φ_{MOD} is a compensation amount of a phase shift intentionally given to the Q-phase optical signal Q2 in order to remove a complex conjugate component included in the Q-phase optical signal Q2 to be described later. In this configuration, φ_{MOD} is set such that φ1+φ2=π. That is, since π/2+φₑᵣᵣ(λ1)+π/2+φ_{MOD}=π, φ_{MOD} is set such that φ_{MOD}=−φₑᵣᵣ(λ1). The phase shifter 22 is also referred to as a second phase shifter.

The I-phase optical signal I2 and the Q-phase optical signal Q2 phase-shifted by the phase shifter 22 are multiplexed by the optical coupler C22. The multiplexed optical signal is output as a quadrature phase-modulated optical signal OUT having the wavelength λ2.

As described above, the wavelength converter 100 can convert the quadrature phase-modulated optical signal IN having the wavelength λ1 into the quadrature phase-modulated optical signal OUT having the wavelength λ2 different from the wavelength λ1.

Next, the operation of the wavelength converter 100 will be described. First, a process in which the reception unit 10 receives the optical signal IN and outputs the I-phase analog signal SI and the Q-phase analog signal SQ will be examined.

Here, the electric field intensity of the optical signal IN is E_{IN}(t)e^{jω}^{₁}^{t}. The electric field intensity of the local oscillation light LO is defined as E_{LO}e^{jω}^{₁}^{t}. t represents time. j is an imaginary unit. ω₁ is a frequency of the optical signal IN and the local oscillation light LO. That is, assuming c is the speed of light, ω₁=2πc/λ1. At this time, the electric field intensity E_{I+} of the I-phase optical signal I1 received by the PD on the + side of the photoelectric converter 15 is expressed by the following formula.

$$[ Formula 1 ]$$

$${E}_{I +} = {E}_{IN} ( t ) {e}^{j {ω}_{1} t} + {E}_{LO} {e}^{j {ω}_{1} t} \qquad [ 1 ]$$

The electric field intensity E_{I-} of the I-phase optical signal I1 received by the PD on the − side of the photoelectric converter 15 is expressed by the following formula.

$$[ Formula 2 ]$$

$${E}_{I -} = {E}_{IN} ( t ) {e}^{j {ω}_{1} t} - {E}_{LO} {e}^{j {ω}_{1} t} \qquad [ 2 ]$$

The electric field intensity E_{Q+} of the Q-phase optical signal Q1 received by the PD on the + side of the photoelectric converter 16 is expressed by the following formula.

$$[ Formula 3 ]$$

$${E}_{Q +} = {E}_{IN} ( t ) {e}^{j {ω}_{1} t} + {E}_{LO} {e}^{j ( {ω}_{1} t + \frac{π}{2} + {φ}_{err} ( λ 1 ) )} \qquad [ 3 ]$$

The electric field intensity E_{Q-} of the Q-phase optical signal Q1 received by the PD on the − side of the photoelectric converter 16 is expressed by the following formula.

$$[ Formula 4 ]$$

$${E}_{Q -} = {E}_{IN} ( t ) {e}^{j {ω}_{1} t} - {E}_{LO} {e}^{j ( {ω}_{1} t + \frac{π}{2} + {φ}_{err} ( λ 1 ) )} \qquad [ 4 ]$$

At this time, the voltage I of the I-phase analog signal SI is expressed by the following formula.

$$[ Formula 5 ]$$

$$\begin{matrix}I = {\vert {E}_{I +} \vert}^{2} - {\vert {E}_{I -} \vert}^{2} = {E}_{I +} * {E}_{I +} - {E}_{I -} * {E}_{I -} \\ = 2 {E}_{IN} ( t ) * {E}_{LO} + 2 {E}_{LO} * {E}_{IN} ( t )\end{matrix} \qquad [ 5 ]$$

The voltage Q of the Q-phase analog signal SQ is expressed by the following formula.

$$[ Formula 6 ]$$

$$\begin{matrix}Q = {\vert {E}_{Q +} \vert}^{2} - {\vert {E}_{Q -} \vert}^{2} = {E}_{Q +} * {E}_{Q +} - {E}_{Q -} * {E}_{Q -} \\ = 2 j {E}_{IN} ( t ) * {E}_{LO} {e}^{j {φ}_{err ( λ 1 )}} - 2 j {E}_{LO} * {E}_{LO} ( t ) {e}^{- j {φ}_{err ( λ 1 )}}\end{matrix} \qquad [ 6 ]$$

Based on the above premise, the intensity of the optical signal OUT output from the transmission unit 20 will be examined. First, in order to facilitate the understanding of the problem to be solved by the wavelength converter 100, an example in which the phase shift given to the Q-phase optical signal Q2 by the transmission unit 20 is simply π/2 as in a general wavelength converter will be described. In this case, the electric field intensity E_{OUT} of the optical signal OUT is expressed by the following formula. Here, ω₂ is a frequency of the transmission light L and the optical signal OUT having the wavelength λ2. That is, ω₂=2πc/λ2.

$$[ Formula 7 ]$$

$${E}_{OUT} = ( I + jQ ) {e}^{j {ω}_{2} t} \qquad [ 7 ]$$

Substituting the formulas [5] and [6] into the formula [7] and arranging the formula, the following formula is obtained.

$$[ Formula 8 ]$$

$$\begin{matrix}{E}_{OUT} = 2 {E}_{LO} * ( 1 + {e}^{- j {φ}_{err} ( λ 1 )} ) {E}_{IN} ( t ) {e}^{j {ω}_{2} t} + 2 {E}_{LO} ( {e}^{j {φ}_{err} ( λ 1 )} ) {E}_{IN} ( t ) * {e}^{j {ω}_{2} t} & [ 8 ]\end{matrix}$$

The first term on the right side of Formula [8] is obtained by multiplying the electric field intensity E_{IN} (t) of the optical signal IN by a constant determined by the shift amount φₑᵣᵣ(λ1) of the phase shift in the phase shifter 12, and thus for example, compensation by general digital signal processing can be performed in a downstream coherent receiver that ultimately receives the optical signal OUT and converts the optical signal OUT into a digital signal. However, the second term on the right side of Formula [8] is obtained by multiplying the complex conjugate E_{IN}(t)* of the electric field intensity E_{IN} (t) of the optical signal IN by a constant determined by the shift amount of the phase shift in the phase shifter 12. Therefore, the complex conjugate component of the second term on the right side interferes with the signal component of the first term on the right side, and the signal quality of the optical signal OUT is deteriorated.

Therefore, in the wavelength converter 100, as described above, φ_{MOD} is set such that the sum of the phase shift φ1=π/2+φₑᵣᵣ(λ1) given to the local oscillation light LO2 by the phase shifter 12 and the phase shift φ2=π/2+φ_{MOD} given to the Q-phase optical signal Q2 by the phase shifter 22 becomes π. As a result, the complex conjugate component of the second term on the right side of Formula [8] is canceled. Hereinafter, a specific description will be given.

In a case where the phase shifter 22 gives a phase shift of π/2+φ_{MOD} obtained by intentionally adding the compensation amount φ_{MOD} to the Q-phase optical signal Q2, the electric field intensity E_{OUT} of the optical signal OUT is expressed by the following formula.

$$[ Formula 9 ]$$

$${E}_{OUT} = ( I + {je}^{j {φ}_{MOD}} Q ) {e}^{j {ω}_{2} t} \qquad [ 9 ]$$

Substituting the formulas [5] and [6] into the formula [9] and arranging the formula, the following formula is obtained.

$$[ Formula 10 ]$$

$${E}_{OUT} = 2 {E}_{LO} * ( 1 + {e}^{j ( {φ}_{MOD} - {φ}_{err} ( λ 1 ) )} ) {E}_{IN} ( t ) {e}^{j {ω}_{2} t} + 2 {E}_{LO} ( 1 - {ε}^{j ( {φ}_{MOD} + {φ}_{err} ( λ 1 ) )} ) {E}_{IN} ( t ) * {e}^{j {ω}_{2} t} \qquad [ 10 ]$$

In order to cancel the complex conjugate component of the second term on the right side in Formula [10], in the wavelength converter 100, the compensation amount φ_{MOD} is set such that the sum of the phase shift φ1=π/2+φₑᵣᵣ(λ1) given to the local oscillation light LO2 by the phase shifter 12 and the phase shift φ2=π/2+φ_{MOD} given to the Q-phase optical signal Q2 by the phase shifter 22 becomes π. Therefore, the compensation amount φ_{MOD} has the same absolute value as the shift amount φₑᵣᵣ(λ1) and has a sign-inverted value.

$$[ Formula 11 ]$$

$${φ}_{MOD} = - {φ}_{err} ( λ 1 ) \qquad [ 11 ]$$

The shift amount φₑᵣᵣ(λ1) can be detected by, for example, measurement in advance. Then, the compensation amount φ_{MOD} can be determined based on Formula [11] in such a way as to compensate the detected shift amount φₑᵣᵣ(λ1). The second term on the right side of Formula [10] can be set to 0 by setting the compensation amount φ_{MOD} by the phase shifter 22. Therefore, the electric field intensity E_{OUT} of the optical signal OUT is as follows.

$$[ Formula 12 ]$$

$${E}_{OUT} = 2 {E}_{LO} * ( 1 + {e}^{- j ( {φ}_{MOD} - {φ}_{err} ( λ 1 ) )} ) {E}_{IN} ( t ) {e}^{j {ω}_{2} t} \qquad [ 12 ]$$

As a result, in the wavelength converter 100, the complex conjugate component that can be included in the optical signal OUT and that is indicated by the second term on the right side of Formula [10] is removed, and deterioration of the signal quality of the optical signal OUT can be prevented.

As described above, according to the wavelength converter 100, the optical signal IN having the wavelength λ1 can be converted into the optical signal OUT having the wavelength λ2 without deteriorating the quality by removing the influence of the complex conjugate component.

It is also conceivable to replace the analog compensation unit 30 in the wavelength converter 100 with a digital signal processing unit and eliminate the imbalance between the I-phase and the Q-phase by digital signal processing. However, in this case, since the power consumption of the digital signal processing unit is large as compared with that of the analog compensation unit 30, it is difficult to respond to the low power consumption required for the wavelength converter. In addition, the digital signal processing has a larger signal delay as compared with the analog signal processing. Therefore, it is also difficult to respond to a demand for higher speed of the wavelength conversion process which is increasingly required in the future.

On the other hand, in the wavelength converter 100, imbalance between the I-phase and the Q-phase can be eliminated without performing digital signal processing. As a result, the wavelength converter 100 is advantageous in that low power consumption and low delay can be achieved as compared with a case where digital signal processing is performed.

### Second Example Embodiment

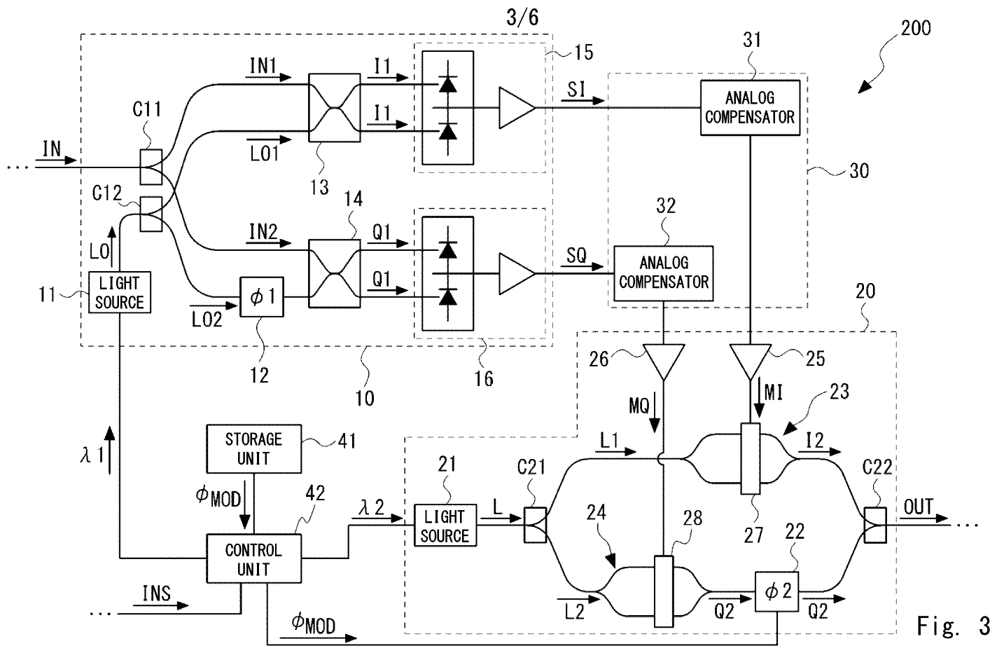

A wavelength converter according to a second example embodiment will be described. FIG. 3 is a diagram schematically illustrating a configuration of a wavelength converter according to one example embodiment. The wavelength converter 200 has a configuration in which a storage unit 41 and a control unit 42 are further provided in the wavelength converter 100.

The wavelength converter 200 is configured to be able to externally designate the wavelength λ1 of the input optical signal IN and the wavelength λ2 of the output optical signal OUT. For example, the wavelength λ1 of the input optical signal IN and the wavelength λ2 of the output optical signal OUT can be designated by externally giving a command INS to the wavelength converter 200.

The storage unit 41 stores a set value of the compensation amount φ_{MOD} included in the phase shift given to the Q-phase optical signal Q2 by the phase shifter 22 according to the wavelength λ1 of the local oscillation light LO and the wavelength λ2 of the transmission light L. The storage unit 41 may store setting information of another reception unit 10, transmission unit 20, and analog compensation unit 30.

The control unit 42 reads the compensation amount φ_{MOD} related to the wavelengths λ1 and λ2 designated by the received command INS from the storage unit 41. Then, the read compensation amount φ_{MOD} is set to the phase shifter 22.

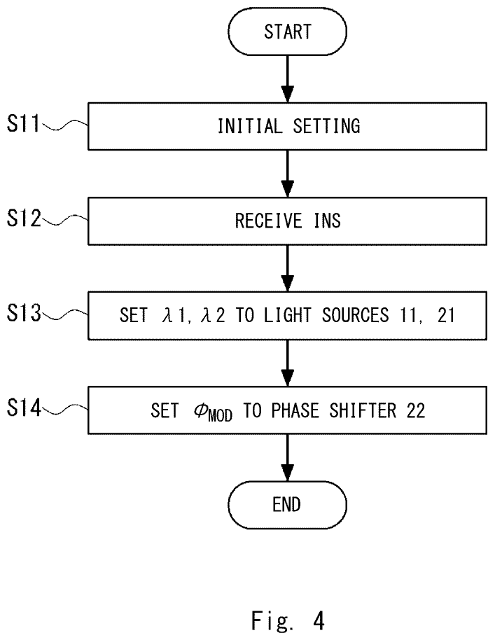

Next, the operation of the wavelength converter 200 will be described. FIG. 4 is a flowchart of an operation of the wavelength converter according to one example embodiment.

### Step S11

The control unit 42 reads the initial setting information of the reception unit 10, the transmission unit 20, and the analog compensation unit 30 from the storage unit 41. Then, the control unit 42 performs initial setting of the reception unit 10, the transmission unit 20, and the analog compensation unit 30 based on the initial setting information.

In the setting of the reception unit 10, for example, a gain of transimpedance for converting a current signal indicating a detection result of an optical signal into a voltage signal in the reception unit 10 may be set. In the setting of the transmission unit 20, for example, the bias of the MZ modulator, the gain of the driver, and the like may be set. In the setting of the analog compensation unit 30, setting such as frequency compensation and skew adjustment of the I-phase and the Q-phase may be performed.

### Step S12

After the initial setting, for example, a user of the wavelength converter 200 gives a command INS to the control unit 42.

### Step S13

The control unit 42 sets the wavelength λ1 designated by the received command INS to the light source 11, and sets the wavelength λ2 to the light source 21.

### Step S14

The control unit 42 reads the compensation amount φ_{MOD} related to the wavelengths λ1 and λ2 designated by the received command INS from the storage unit 41. Then, the control unit 42 sets the read compensation amount φ_{MOD} to the phase shifter 22.

In a case where the settings of the reception unit 10, the transmission unit 20, and the analog compensation unit 30 are updated according to the wavelength settings of the light sources 11 and 12, the control unit 42 may read necessary setting information from the storage unit 41 as appropriate and update the settings of the reception unit 10, the transmission unit 20, and the analog compensation unit 30.

As described above, according to the wavelength converter 200, an appropriate phase shift can be set to the phase shifter 22 according to the wavelength λ1 of the input optical signal IN and the wavelength λ2 of the output optical signal OUT. As a result, even if the wavelength λ1 of the optical signal IN and the wavelength λ2 of the optical signal OUT are changed, the complex conjugate component in the optical signal OUT can be suitably canceled.

### Third Example Embodiment

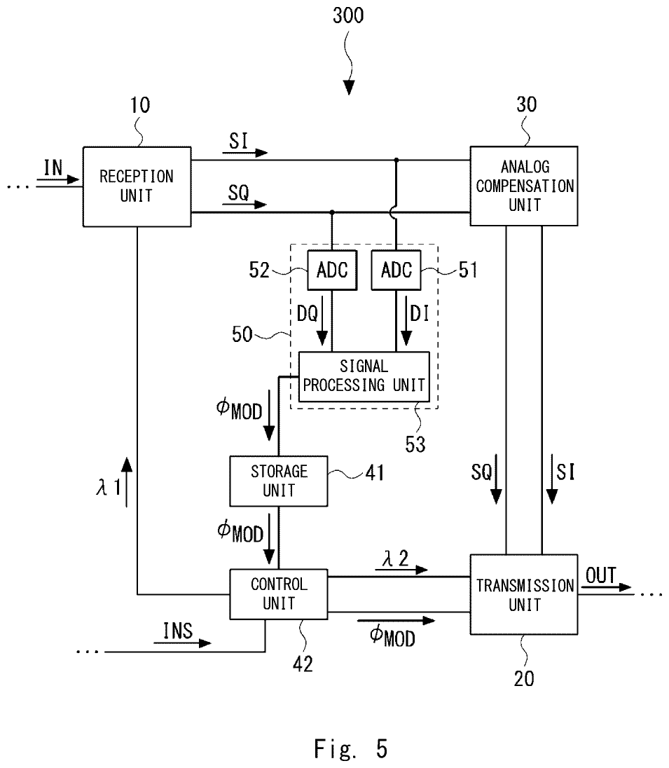

A wavelength converter according to a third example embodiment will be described. FIG. 5 is a diagram schematically illustrating a configuration of a wavelength converter according to one example embodiment. A wavelength converter 300 has a configuration in which a processing unit 50 is further provided in the wavelength converter 200.

The processing unit 50 includes analog-digital converters (hereinafter referred to as ADC) 51 and 52 and a signal processing unit 53. The ADCs 51 and 52 convert the I-phase analog signal SI and the Q-phase analog signal SQ output from the reception unit 10 into digital signals DI and DQ, respectively. The signal processing unit 53 calculates a compensation amount φ_{MOD} of the phase shift to be set to the phase shifter 22 based on the digital signals DI and DQ.

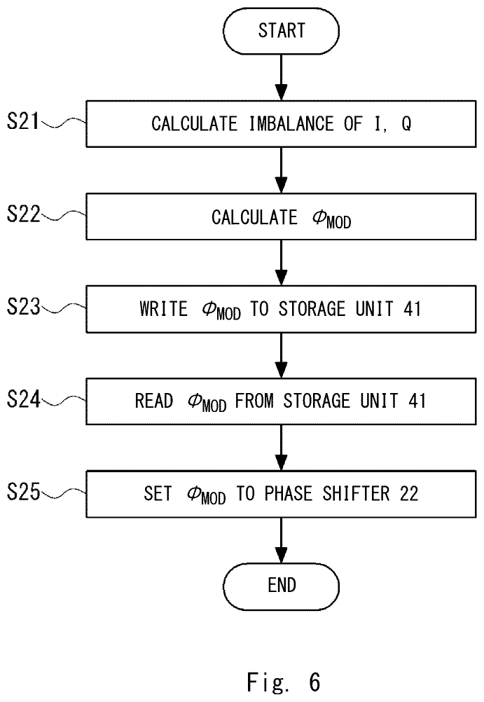

Next, the operation of the wavelength converter 300 will be described. FIG. 6 is a flowchart of an operation of the wavelength converter according to one example embodiment.

### Step S21

The signal processing unit 53 calculates an imbalance between the I-phase and the Q-phase based on the digital signals DI and DQ.

### Step S22

The signal processing unit 53 calculates a compensation amount φ_{MOD} of the phase shift to be set to the phase shifter 22 appropriate for eliminating the calculated imbalance between the I-phase and the Q-phase. The signal processing unit 53 may calculate setting information of the reception unit 10, the transmission unit 20, and the analog compensation unit 30 other than the compensation amount φ_{MOD} of the phase shift in order to eliminate the imbalance between the I-phase and the Q-phase.

### Step S23

The signal processing unit 53 writes the calculated phase shift compensation amount φ_{MOD} into the storage unit 41. The signal processing unit 53 may write the setting information of the reception unit 10, the transmission unit 20, and the analog compensation unit 30 calculated other than the compensation amount φ_{MOD} of the phase shift in the storage unit 41 in order to eliminate the imbalance between the I-phase and the Q-phase.

### Step S24

The control unit 42 reads the compensation amount φ_{MOD} of the phase shift written in the storage unit 41 written by the signal processing unit 53. Then, the control unit 42 sets the read compensation amount φ_{MOD} of the phase shift to the phase shifter 22. The control unit 42 may read the setting information of the reception unit 10, the transmission unit 20, and the analog compensation unit 30 written in the storage unit 41 by the signal processing unit 53 to update the settings of the reception unit 10, the transmission unit 20, and the analog compensation unit 30.

As a result, the wavelength converter 300 can perform feedback control for setting each unit in such a way that the imbalance is eliminated according to the observation result of the imbalance between the I-phase and the Q-phase. As a result, the wavelength converter 300 can more efficiently maintain the quality of the optical signal OUT after the wavelength conversion.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Although the wavelength converter for wavelength-converting the quadrature phase-modulated optical signal has been described in the example embodiment described above, the wavelength converter according to the example embodiment described above can also be applied to an optical signal of other modulation systems. For example, in dual polarization-quadrature phase shift keying (DP-QPSK) as well, wavelength conversion can be similarly performed on the QPSK signal of each polarization component after performing polarization separation. That is, even in the case of an optical signal modulated by combining the quadrature phase-modulated with another modulation system, wavelength conversion can be performed by the wavelength converter according to the example embodiment described above by converting a target optical signal into a quadrature phase-modulated optical signal by a demultiplexing means or the like.

Each of the drawings is merely an example to illustrate one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing exemplary example embodiments are not necessarily mandatory, and some features or steps may be omitted. The order of the steps described in any of the drawings may be changed as appropriate.

Some or all of the above-described example embodiments may be described as the following supplementary notes, but are not limited to the following supplementary notes.

### Supplementary Note 1

A wavelength converter including a reception means for receiving a quadrature phase-modulated optical signal of a first wavelength, splitting the received optical signal into first and second optical signals, causing the first optical signal to interfere with a first local oscillation light of the first wavelength, and causing the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals, an analog compensation means for performing analog compensation on the in-phase analog signal and the quadrature phase analog signal, and a transmission means for modulating first and second transmission light of a second wavelength different from the first wavelength into a first in-phase optical signal and a first quadrature phase optical signal, respectively, based on the analog compensated in-phase analog signal and quadrature phase analog signal, shifting a phase of the first quadrature phase optical signal to cancel a shift amount included in a phase shift given to the second local oscillation light by the reception means, multiplexing the first in-phase optical signal and the first quadrature phase optical signal after the phase shift, and outputting a quadrature phase-modulated optical signal of the second wavelength.

### Supplementary Note 2

The wavelength converter according to supplementary note 1, in which the reception means includes a first light source for outputting light of the first wavelength, a first optical splitting means for splitting the optical signal of the first wavelength into the first and second optical signals, a second optical splitting means for splitting the light of the first wavelength into the first and second local oscillation lights, a first phase shifter for shifting a phase of the second local oscillation light such that the second local oscillation light has a quadrature phase with respect to the first local oscillation light, an interfering means for outputting a second in-phase optical signal by causing the first optical signal to interfere with the first local oscillation light,—and for outputting a second quadrature phase optical signal by causing the second optical signal to interfere with the second local oscillation light whose phase is shifted by the first phase shifter, and a photoelectric conversion means for converting the second in-phase optical signal and the second quadrature phase optical signal into the in-phase analog signal and the quadrature phase analog signal, and the transmission means includes a light source for outputting light of the second wavelength, a third optical splitting means for splitting the light of the second wavelength into the first and second transmission light, first and second drivers for outputting an in-phase modulation signal and a quadrature phase-modulation signal based on the analog compensated in-phase analog signal and the quadrature phase analog signal, a first modulator for modulating the first transmission light according to the in-phase modulation signal and output the first in-phase optical signal a second modulator for modulating the second transmission light according to the quadrature phase-modulation signal and output the first quadrature phase optical signal, a second phase shifter for shifting a phase of the first quadrature phase optical signal to cancel a shift amount included in a phase shift given to the second local oscillation light by the first phase shifter, and an optical multiplexing means for multiplexing the first in-phase optical signal and the first quadrature phase optical signal whose phase has been shifted by the second phase shifter and outputting the quadrature phase-modulated optical signal of the second wavelength.

### Supplementary Note 3

The wavelength converter according to supplementary note 2, in which the second phase shifter shifts a phase of the first quadrature phase optical signal such that a sum of the phase shift given to the second local oscillation light by the first phase shifter and a phase shift given to the first quadrature phase optical signal by the second phase shifter is π.

### Supplementary Note 4

The wavelength converter according to supplementary note 3, in which the phase shift given to the second local oscillation light by the first phase shifter is a value obtained by adding a shift amount to π/2, the phase shift given to the first quadrature phase optical signal by the second phase shifter is a value obtained by adding a compensation amount to π/2, and the compensation amount is a value having an opposite sign and the same magnitude with respect to the shift amount.

### Supplementary Note 5

The wavelength converter according to supplementary note 4, further including: a storage means for storing information indicating the compensation amount according to the first wavelength and the second wavelength, and a control means for reading the information indicating the compensation amount from the storage means according to the first wavelength and the second wavelength, and setting the compensation amount to the second phase shifter based on the read information.

### Supplementary Note 6

The wavelength converter according to supplementary note 5, in which the control means receives a command designating the first wavelength and the second wavelength, and reads the information indicating the compensation amount from the storage means according to the first wavelength and the second wavelength designated by the received command.

### Supplementary Note 7

The wavelength converter according to supplementary note 5 or 6, further including a processing means for calculating an imbalance between the in-phase analog signal and the quadrature phase analog signal, and calculating the compensation amount to be set for eliminating an influence of the calculated imbalance, in which the control means sets the compensation amount calculated by the processing means to the second phase shifter.

### Supplementary Note 8

The wavelength converter according to any one of supplementary notes 2 to 7, in which the interfering means includes a first splitting means for splitting the second in-phase optical signal obtained by causing the first optical signal to interfere with the first local oscillation light into two and outputting the two complementary optical signals, and a second splitting means for splitting the second quadrature phase optical signal obtained by causing the second optical signal to interfere with the second local oscillation light whose phase has been shifted by the first phase shifter into two and outputting the two complementary optical signals, and the photoelectric conversion means includes a first photoelectric converter configured as a balanced detector that receives the second in-phase optical signal branched into two and converts the second in-phase optical signal into the in-phase analog signal, and a second photoelectric converter configured as a balanced detector that receives the second quadrature phase optical signal branched into two and converts the second quadrature phase optical signal into the quadrature phase analog signal.

### Supplementary Note 9

A wavelength conversion method including: receiving a quadrature phase-modulated optical signal of a first wavelength, splitting the received optical signal into first and second optical signals, causing the first optical signal to interfere with a first local oscillation light of the first wavelength, and causing the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals, performing analog compensation on the in-phase analog signal and the quadrature phase analog signal, modulating first and second transmission light of a second wavelength different from the first wavelength into a first in-phase optical signal and a first quadrature phase optical signal, respectively, based on the analog compensated in-phase analog signal and quadrature phase analog signal, shifting a phase of the first quadrature phase optical signal to cancel a shift amount included in a phase shift given to the second local oscillation light, multiplexing the first in-phase optical signal and the first quadrature phase optical signal after the phase shift, and outputting a quadrature phase-modulated optical signal of the second wavelength.

What is claimed is:

1. A wavelength converter comprising:
a reception unit configured to receive a quadrature phase-modulated optical signal of a first wavelength, split the received optical signal into first and second optical signals, cause the first optical signal to interfere with a first local oscillation light of the first wavelength, and cause the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals;
an analog compensation unit configured to perform analog compensation on the in-phase analog signal and the quadrature phase analog signal; and
a transmission unit configured to modulate first and second transmission lights of a second wavelength different from the first wavelength into a first in-phase optical signal and a first quadrature phase optical signal, respectively, based on the analog compensated in-phase analog signal and quadrature phase analog signal, shift a phase of the first quadrature phase optical signal to cancel a shift amount included in a phase shift given to the second local oscillation light by the reception unit, multiplex the first in-phase optical signal and the first quadrature phase optical signal after the phase shift, and output a quadrature phase-modulated optical signal of the second wavelength.

2. The wavelength converter according to claim 1, wherein
the reception unit includes
a first light source configured to output light of the first wavelength,
a first optical splitting unit configured to split the optical signal of the first wavelength into the first and second optical signals,
a second optical splitting unit configured to split the light of the first wavelength into the first and second local oscillation lights,
a first phase shifter configured to shift a phase of the second local oscillation light such that the second local oscillation light has a quadrature phase with respect to the first local oscillation light,
an interfering unit configured to output a second in-phase phase optical signal by causing the first optical signal to interfere with the first local oscillation light, and output a second quadrature phase optical signal by causing the second optical signal to interfere with the second local oscillation light whose phase is shifted by the first phase shifter, and
a photoelectric converter configured to convert the second in-phase optical signal and the second quadrature phase optical signal into the in-phase analog signal and the quadrature phase analog signal; and
the transmission unit includes
a light source configured to output light of the second wavelength,
a third optical splitting unit configured to split the light of the second wavelength into the first and second transmission light,
first and second drivers configured to output an in-phase modulation signal and a quadrature phase modulation signal based on the analog compensated in-phase analog signal and quadrature phase analog signal,
a first modulator configured to modulate the first transmission light according to the in-phase modulation signal and output the first in-phase optical signal,
a second modulator configured to modulate the second transmission light according to the quadrature phase modulation signal and output the first quadrature phase optical signal,
a second phase shifter configured to shift a phase of the first quadrature phase optical signal to cancel a shift amount included in a phase shift given to the second local oscillation light by the first phase shifter, and
an optical multiplexing unit configured to multiplex the first in-phase optical signal and the first quadrature phase optical signal whose phase has been shifted by the second phase shifter and output the quadrature phase-modulated optical signal of the second wavelength.

3. The wavelength converter according to claim 2, wherein the second phase shifter shifts a phase of the first quadrature phase optical signal such that a sum of the phase shift given to the second local oscillation light by the first phase shifter and a phase shift given to the first quadrature phase optical signal by the second phase shifter is π.

4. The wavelength converter according to claim 3, wherein
the phase shift given to the second local oscillation light by the first phase shifter is a value obtained by adding a shift amount to π/2,
the phase shift given to the first quadrature phase optical signal by the second phase shifter is a value obtained by adding a compensation amount to π/2, and
the compensation amount is a value having an opposite sign and the same magnitude with respect to the shift amount.

5. The wavelength converter according to claim 4, further comprising:
a storage unit configured to store information indicating the compensation amount according to the first wavelength and the second wavelength; and
a control unit configured to read the information indicating the compensation amount from the storage unit according to the first wavelength and the second wavelength, and set the compensation amount to the second phase shifter based on the read information.

6. The wavelength converter according to claim 5, wherein the control unit receives a command designating the first wavelength and the second wavelength, and reads the information indicating the compensation amount from the storage unit according to the first wavelength and the second wavelength designated by the received command.

7. The wavelength converter according to claim 5, further comprising a processing unit configured to calculate an imbalance between the in-phase analog signal and the quadrature phase analog signal, and calculate the compensation amount to be set for eliminating an influence of the calculated imbalance,
wherein the control unit sets the compensation amount calculated by the processing unit to the second phase shifter.

8. The wavelength converter according to claim 2, wherein
the interfering unit includes
a first interfering unit configured to split the second in-phase optical signal obtained by causing the first optical signal to interfere with the first local oscillation light into two and output the two complementary optical signals, and
a second interfering unit configured to split the second quadrature phase optical signal obtained by causing the second optical signal to interfere with the second local oscillation light whose phase has been shifted by the first phase shifter into two and output the two complementary optical signals; and
the photoelectric converter includes
a first photoelectric converter configured as a balanced detector that receives the second in-phase optical signal branched into two and converts the second in-phase optical signal into the in-phase analog signal, and
a second photoelectric converter configured as a balanced detector that receives the second quadrature phase optical signal branched into two and converts the second quadrature phase optical signal into the quadrature phase analog signal.

9. A wavelength conversion method comprising:
receiving a quadrature phase-modulated optical signal of a first wavelength;
splitting the received optical signal into first and second optical signals;
causing the first optical signal to interfere with a first local oscillation light of the first wavelength, and causing the second optical signal to interfere with second local oscillation light of the first wavelength whose phase has been shifted to be in quadrature phase to the first local oscillation light to output an in-phase analog signal and a quadrature phase analog signal indicating a coherent detection result of the first and second optical signals;
performing analog compensation on the in-phase analog signal and the quadrature phase analog signal;
modulating first and second transmission light of a second wavelength different from the first wavelength into a first in-phase optical signal and a first quadrature phase optical signal, respectively, based on the analog compensated in-phase analog signal and quadrature phase analog signal;
shifting a phase of the first quadrature phase optical signal to cancel a shift amount included in a phase shift given to the second local oscillation light; and
multiplexing the first in-phase optical signal and the first quadrature phase optical signal after the phase shift, and outputting a quadrature phase-modulated optical signal of the second wavelength.
